(19) United States
(12) Patent Application Publication
(10) Pub. No.: US 2009/0259865 A1
(43) Pub. Date: Oct. 15, 2009

(54) Power Management Using At Least One Of A Special Purpose Processor And Motion Sensing

(75) Inventors: Leonid Sheynblat, Hillsborough, CA (US); Thomas G. Wolf, Mountain View, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/101,930

(22) Filed: Apr. 11, 2008

(51) Int. Cl. G06F 1/26

(52) U.S. Cl. 713/323

(57) ABSTRACT

A power management device useable in a mobile station includes a main processor configured to execute applications including signal processing applications and further configured to enter a sleep mode in response to predetermined criteria. The device further includes a circuit configured to operate when the main processor is in the sleep mode comprising at least one of a low power processor and a sensor to monitor at least one of signals, commands, inputs, and changes in environment, the circuit waking up the main processor responsive to one of the low power processor and the sensor. The device may operate a method and may execute instructions based on a machine readable medium.

### BACKGROUND

1. Field

The device and method herein are directed generally to managing power in processors implementing periodic processing and, more particularly, mobile stations managing power in processors implementing wireless signal processing along with other applications.

2. Background

Many devices, such as mobile stations and the like, include circuits for implementing algorithms, such as algorithms for the detection of wireless signals and the like. Such circuits are typically implemented using a processor that provides functionality to detect signals along with other functionality. In particular, these processors will typically provide functionality of one or more of video, communication, entertainment, guidance, location functionality and the like. All of these various functionalities have a tendency to consume a great deal of power. The power in this case can be from a battery, electrical cells, and the like. However, the processor often remains idle and does not need to be active to provide all of the various functionalities noted above because it is not often needed by a user. When remaining idle, though, the processor will continue to consume a relatively large amount of power. This consumption of power will have a tendency to shorten the life of the battery and require the user to charge the same more often.

In order to combat the consumption of power, there have been attempts to operate a mobile station to reduce power consumption by placing the processor in a “sleep mode.” This solution also includes “waking up” the processor to check inputs and the like either periodically or responsive to interrupts. The result of sleep mode however is that the processor will have, amongst other things, poorer performance such as failing to receive data, commands, and so on. This periodic waking up also consumes a relatively large amount of power. In other words, the processor may be awakened periodically only to find that there is no input or processing to take place. Accordingly, the power consumed during the waking up process has been wasted.

Accordingly, there is a need to reduce power consumption by operating a processor only during times when the processor is needed while avoiding poor performance during such non-operating times.

### SUMMARY

The device and method meet the foregoing need and avoid the disadvantages and drawbacks of the prior art by providing a device and method that may include a secondary low power processor to provide for various functionality to allow the processor (hereinafter main processor), when not executing complex applications, to enter sleep mode. The low power processor then improves sleep mode performance by receiving input and saving data as needed and functions to awaken the main processor as needed. Accordingly, the low power processor may be optimized for sleep mode operations and the main processor may be optimized for complex applications.

The device and method further or alternatively may include a sensor arrangement to sense changes. The sensor senses changes in the surroundings, such as motion, temperature, direction, acceleration, barometric pressure, magnetic field, and light, in order to ascertain a need for providing full main processor functionality and thus awaken the main processor for providing the full functionality to systems therewith.

While the device and method are particularly advantageous for signal detection algorithms used in a mobile station for Satellite Positioning System (SPS) and/or wireless communicating in wireless communication systems, the skilled artisan will appreciate that the device and method is applicable to other applications, including any applications involving periodic digital signal processing having similar problems as those described herein.

In one aspect, a method of managing power in a mobile station includes the steps of executing applications including signal processing applications, entering a sleep mode in response to predetermined criteria, monitoring at least one of signals, commands, inputs, and changes in environment when in the sleep mode, and waking up responsive to the step of monitoring at least one of signals, commands, inputs, and changes in environment.

The step of monitoring may include monitoring with a low power processor. The method of managing power in a mobile station may further include the step of storing at least one of the inputs, signals, and commands in a memory for subsequent processing by a main processor. The step of waking up in response to the step of monitoring may include monitoring at least one of the inputs, signals, and commands received in the mobile station exceeding a threshold. The step of monitoring may include sensing a change in the environment. The change in environment may include at least one of motion, temperature, direction, acceleration, magnetic field, and light. The step of sensing initiates the step of waking up in response to a sensed change in environment that exceeds a predetermined threshold. The predetermined criteria may include at least one of a period of user inactivity, a reduced reception of wireless signals, no change in position, and no changes in the environment. The method of managing power in a mobile station may further include the step of receiving wireless signals.

In another aspect, a power management circuit in a mobile station includes a main processor configured to execute applications including signal processing applications and further configured to enter a sleep mode in response to predetermined criteria, and a circuit configured to operate when the main processor is in the sleep mode includes at least one of a low power processor and a sensor to monitor at least one of signals, commands, inputs, and changes in environment, the circuit waking up the main processor responsive to one of the low power processor and the sensor.

The circuit may include the low power processor and wherein the low power processor may be configured to monitor at least one of the inputs, signals, and commands in the mobile station. The low power processor may be configured to store at least one of the inputs, signals, and commands in a memory for subsequent processing by the main processor. The low power processor may be configured to wake up the main processor in response to the monitoring of at least one of the inputs, signals, and commands received in the mobile station exceeding a threshold. The circuit may include the sensor and the sensor may be configured to sense a change in the environment. The change in environment may include at least one of motion, temperature, direction, acceleration, magnetic field, and light. The sensor may be configured to wake up the main processor in response to a sensed change in environment that exceeds a predetermined threshold. The predetermined criteria may include at least one of a period of user inactivity, a reduced reception of wireless signals, no change in position, and no changes in the environment. The power management circuit further may include a radio frequency unit configured to receive wireless signals. The low power processor may be integrated into one of the main processor and the radio frequency unit.

In a further aspect, a machine-readable medium includes instructions, which, when executed by at least a main processor cause the main processor to manage power in a mobile station, the instructions include instructions to execute applications in a main processor including signal processing applications, instructions to enter a sleep mode in response to predetermined criteria, instructions to monitor at least one of signals, commands, inputs, and changes in environment when the main processor may be in the sleep mode with at least one of a low power processor and a sensor, and instructions to wake up the main processor responsive to one of the low power processor and the sensor.

The machine-readable medium may further include instructions to store at least one of the inputs, signals, and commands in a memory for subsequent processing by the main processor. The machine-readable medium may further include instructions to wake up in response to the instructions to monitor at least one of the inputs, signals, and commands received in the mobile station exceeding a threshold. The instructions to monitor may include instructions to sense a change in the environment. The change in environment may include at least one of motion, temperature, direction, acceleration, magnetic field, and light. The instructions to sense may initiate the instructions to wake up in response to a sensed change in environment that exceeds a predetermined threshold. The predetermined criteria may include at least one of a period of user inactivity, a reduced reception of wireless signals, no change in position, and no changes in the environment. The machine-readable medium further may include instructions to receive a wireless signals.

A power management circuit in a mobile station includes means for executing applications including signal processing applications, means for placing the executing means in a sleep mode in response to predetermined criteria, means for monitoring at least one of signals, commands, inputs, and changes in environment when the executing means is in the sleep mode, and means for waking up responsive to the monitoring means.

The monitoring means may include means for low power processing and wherein the low power processing means may be configured to monitor at least one of the inputs, signals, and commands in the mobile station. The low power processing means may be configured to store at least one of the inputs, signals, and commands in a memory for subsequent processing by the executing means. The low power processing means may be configured to wake up the executing means in response to the monitoring of at least one of the inputs, signals, and commands received in the mobile station exceeding a threshold. The power management circuit may include means for sensing a change in the environment. The change in environment may include at least one of motion, temperature, direction, acceleration, magnetic field, and light. The sensing means may be configured to wake up the executing means in response to a sensed change in environment that exceeds a predetermined threshold. The predetermined criteria may include at least one of a period of user inactivity, a reduced reception of wireless signals, no change in position, and no changes in the environment. The power management circuit further may include a radio frequency receiving means for receiving wireless signals. The low power processor may be integrated into one of the executing means and the radio frequency receiving means.

Additional features, advantages, and aspects of the device and method may be set forth or apparent from consideration of the following detailed description, drawings, and claims. Moreover, it is to be understood that both the foregoing summary and the following detailed description are exemplary and intended to provide further explanation without limiting the scope of the device and methods as claimed.

### BRIEF DESCRIPTION OF THE DRAWINGS

The accompanying drawings, which are included to provide a further understanding of the device and method, are incorporated in and constitute a part of this specification, illustrate aspects of the device and method and together with the detailed description serve to explain the principles of the device and method. No attempt is made to show structural details of the device and method in more detail than may be necessary for a fundamental understanding of the device and method and the various ways in which they may be practiced. In the drawings:

FIG. 1 is a schematic diagram showing a device in a mobile station;

FIG. 2 is a flow chart showing a method that may be used with the device of FIG. 1;

FIG. 3 is a schematic diagram showing another device in a mobile station;

FIG. 4 is another flowchart showing a method that may be used with the device of FIG. 3;

FIG. 5 is a schematic diagram showing another device in a mobile station;

FIG. 6 is a schematic diagram showing another device that may be used in a mobile station;

FIG. 7 is a schematic diagram showing an implementation of two different mobile stations together in a satellite and/or cellular system; and

FIG. 8 is a schematic diagram showing yet another device that may be used in other applications besides mobile stations.

### DETAILED DESCRIPTION

The aspects of the device and method and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the device and methods. The examples used herein are intended merely to facilitate an understanding of ways in which the device and methods may be practiced and to further enable those of skill in the art to practice the aspects of the device and methods. Accordingly, the examples and aspects herein should not be construed as limiting the scope of the device and methods, which is defined solely by the appended claims and applicable law. Moreover, it is noted that like reference numerals represent similar parts throughout the several views of the drawings.

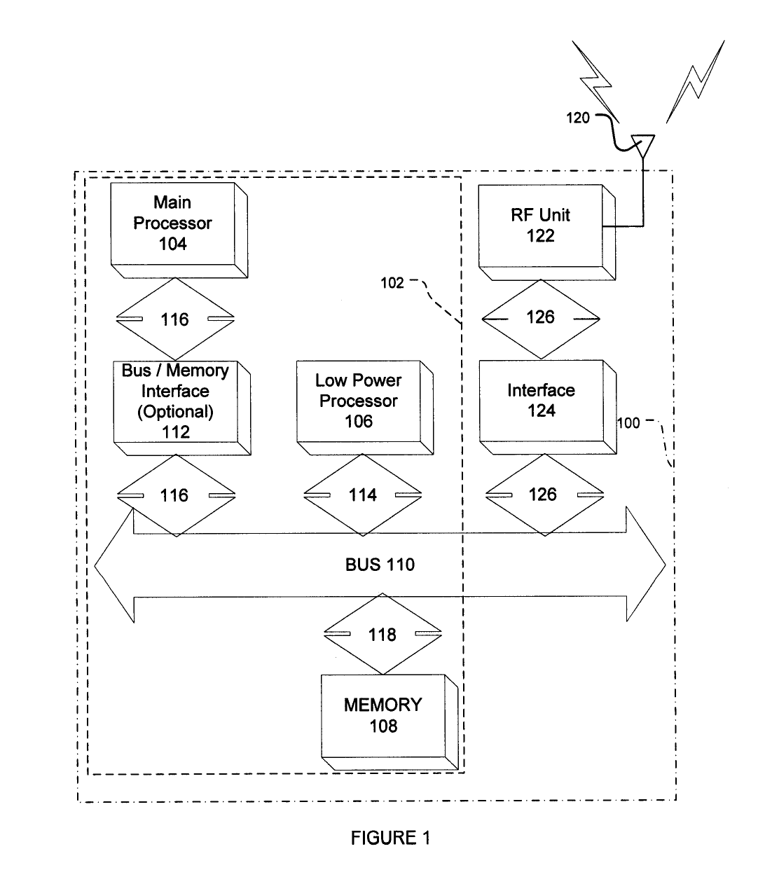

FIG. 1 is a schematic diagram showing a device in a mobile station. More specifically, FIG. 1 shows an arrangement and configuration of a mobile station 100 for use in receiving wireless signals from a Satellite Positioning System (SPS), a wireless communications system, or the like. The mobile station 100 includes a circuit 102 that may implement an algorithm, such as a digital signal processing algorithm, for wireless signal detection or acquisition.

The mobile station 100 may include an antenna 120 to receive a wireless signal. The wireless signal may be any of the radio access technologies (RATs) described below. The wireless signal may be received into a radio frequency (RF) unit 122 in a manner well known in the art. An interface 124, as shown in FIG. 1, may be responsive to the radio frequency unit 122. The interface 124 may include one or more components, including links 126,126, to process the wireless signal and receive the signal into the circuit 102 for further processing.

A main processor 104 may interact with data and/or control signals via a bus/memory interface 112 via interfaces 116,116 to bus 110. Such an interface may be optional and other components, including a low power processor described below, may communicate with the main processor 104 in any known manner.

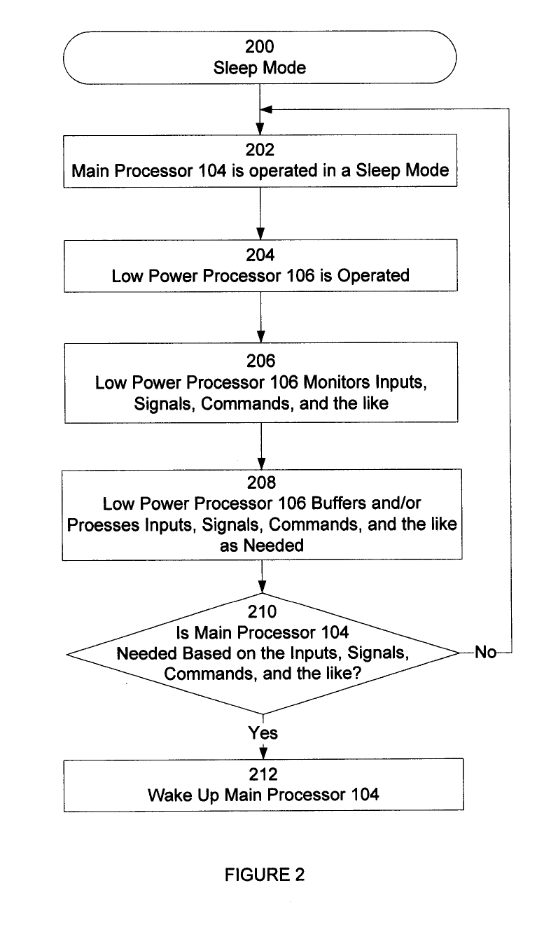

FIG. 1 further shows a low power processor 106 that may have less computing power and consume less power than the main processor 104. Moreover the low power processor 106 may be configured to be optimized for lower power operation. In this regard, the main processor 104 may be operated in a sleep mode and the low power processor 106 may operate continuously or on a high duty cycle compared to that of the main processor 104 in order to conserve power. The low power processor 106 may also include more limited interfaces and memory. The low power processor 106 may function to monitor the inputs received via interface 124, links 126 or other inputs as is known in the art. In this regard, the low power processor 106 may monitor the inputs, signals, commands or any other data as is known in the art received or generated in the mobile station 100. The low power processor 106 also may function to process, buffer, and so on the data from the inputs and store the input data in, for example, a memory 108. In addition to processing and buffering, the low power processor may also filter, condense and/or combine inputs. By operating the low power processor 106 instead of the main processor 104 during certain times, the overall power consumption of the circuit may be reduced. The method of operation is discussed in greater detail below in conjunction with FIG. 2.

It should be noted that the arrangement of the various components shown in FIG. 1 is merely exemplary. In that regard, the circuit 102 may include more or less components, a different arrangement of more or less components, and so on. The arrangement of FIG. 1 is exemplary and other arrangements are contemplated as long as the circuit 102 includes a low power processor 106 that allows the main processor 104 to enter sleep mode. Moreover, in order to reduce manufacturing costs and/or component size, the low power processor 106 may be integrated with and on the same chip as the main processor 104, in one of more sensor devices such as the RF unit 122, or the like. The method of operation will now be discussed in conjunction with FIG. 2.

FIG. 2 is a flow chart showing a method that may be used with the device of FIG. 1. In particular, FIG. 2 shows a method of operation of a mobile station, such as mobile station 100, when in a sleep mode 200. A mobile station 100 may enter sleep mode in response to any one of a number of criteria. The criteria may include a period of inactivity by the user, inactivity with respect to receiving wireless signals, a negligible change in position as determined by SPS signals, and the like. As shown in step 202, the main processor 104 may be placed into a sleep mode after the above-noted criteria is achieved. The sleep mode may allow the main processor 104 to conserve power by the inactivation thereof. The main processor 104 may not be operated such that it wakes up at a frequency as high as that of the prior art. Instead, the low power processor 106 may be activated as shown in step 204. The low power processor 106 may provide the same monitoring functionality as that of the main processor 104 would during the various wake ups that would occur in the prior art.

As shown in step 206, the low power processor 106 may operate to monitor the various inputs. The inputs may include the various wired or wireless signals such as the wireless signals received by antenna 120, RF unit 122 through links 126 and interface 124. The inputs may further include user inputs through an input device not shown. Other inputs may be from various other sources via bus 110, memory 108, and so on. The low power processor 106 may take the various inputs that include inputs, signals, commands, and the like and may buffer those in memory 108 via link 118 and/or may process the inputs, signals, commands, and the like as is well known in the art. Accordingly, when the main processor 104 is awakened, the various inputs, signals, commands, and the like may have been processed and/or may have been stored and may be ready for use, processing, and the like by main processor 104.

Next as shown in step 210, the low power processor 106 may also make a determination whether or not to wake up the main processor 104. Such criteria may be the need to process information that can only be processed by the main processor 104. Alternatively or additionally, the receipt of enough inputs, signals, and/or commands that the memory 108 may be approaching being full may be another basis for the low power processor 106 to awaken the main processor 104 to process according. The main processor 104 may also be awakened if the low power processor 106 determines that sufficient time has elapsed since the main processor 104 was last awake. The main processor 104 may also be awakened if a fault or other change in operating conditions is detected. Accordingly, as shown in logic step 210, when the main processor 104 is needed, the main processor 104 is awakened as shown in logic step 212. On the other hand, if it is determined in logic step 210 that the main processor 104 may not needed, the flow of logic may return back to logic step 202 to keep the main processor 104 in the sleep mode.

It should be noted that the low power processor 106 may operate to monitor more or less processes or actions as noted above. Additionally, it should be noted that the low power processor 106 in addition to monitoring inputs and buffering the various signals, may provide a certain level of processing as may be required and not described in further detail herein. Finally, it should be noted that the low power processor 106 may also provide additional functionality in conjunction with the main processor 104, when the main processor 104 is in the awake mode such as providing parallel processing or other functions.

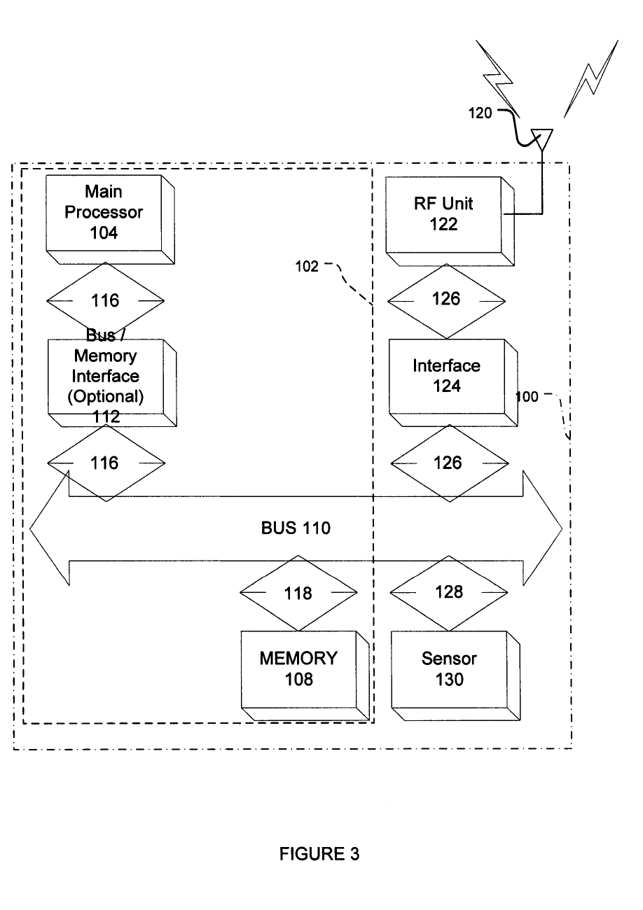

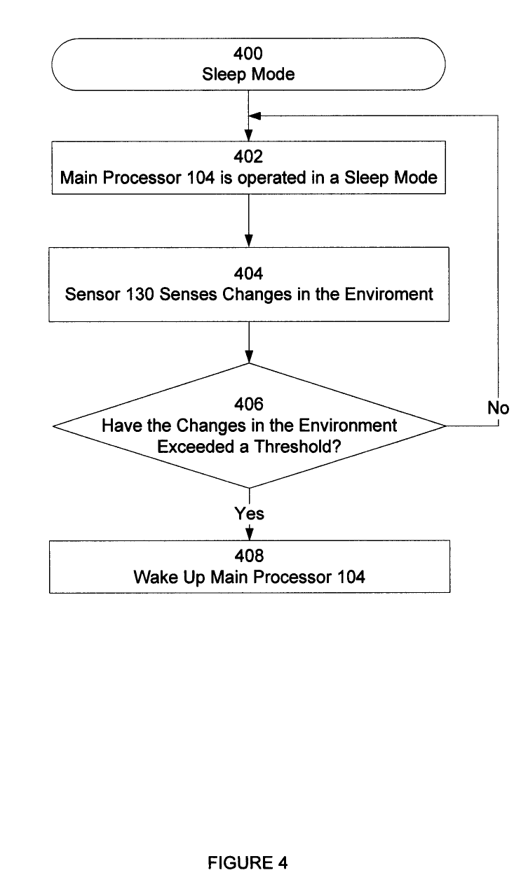

FIG. 3 is a schematic diagram showing another device in a mobile station. In particular, FIG. 3 shows a mobile station 100 that may include a sensor 130 that is linked to the bus 110 or other logical connection to the mobile station 100 and possibly to the circuit 102 via a link 128. The sensor 130 may be configured in order to sense various environmental changes that may trigger the awakening of the main processor 104 when the main processor 104 is in a sleep mode. In this regard, the sensor 130 may sense various environmental changes including position, motion, light, temperature, pressure, magnetic field, and so on. In one aspect of the method and device herein, the sensor 130 may be configured to measure motion. Accordingly, when the sensor 130 measures motion that is above a particular threshold, the sensor may awaken the main processor 104 as described in further detail in conjunction with FIG. 4 below.

The sensor 130 may be implemented in a number of different ways, in one aspect the sensor 130 may be implemented as an accelerometer. An accelerometer is a device that measures acceleration. Accordingly, if the mobile station 100 experiences motion, the mobile station will also experience acceleration. The acceleration may be measured by the accelerometer. Such accelerometers may use any known technology including strain gauge, piezoelectric technology, and so on.

The sensor 130 may also be configured as a barometric pressure sensor, baroaltimeter, and the like. These various types of sensors measure a change in air pressure (e.g. to determine altitude) of the sensor 130 and hence the mobile station 100. In this regard, a change in altitude is indicative of a motion.

The sensor 130 may alternatively be implemented as a sensor that measures the earth's geomagnetic field. Accordingly, a change in orientation of the mobile station 100 may be sensed by the sensor 130 when implemented as a geomagnetic field sensor. A sensor that senses the gravitational field may also be implemented. Finally, the sensor 130 may include any combination of sensor capabilities, including those noted above or known to those skilled in the art.

Accordingly, the sensor 130 may be configured to wake up the main processor 104 when the environment changes more than a threshold amount as described below with reference to FIG. 4. It should be noted that sensor 130 may accordingly measure any change in environment, and such is contemplated for use herein.

FIG. 4 is another flowchart showing a method that may be used with the device of FIG. 3. FIG. 4 shows a sleep mode 400 being activated for the main processor 104 based on the same criteria as noted above with respect to sleep mode 200. Accordingly, the main processor 104 may be put into sleep mode in step 402. As shown in step 404, during sleep mode the sensor 130 may sense the environmental conditions noted above. As shown in step 406, when these sensed environmental changes exceed a predetermined or dynamic threshold, the logic may flow to step 408 that may awaken the main processor 104 to begin processing as is well known in the art. On the other hand, if the threshold is not exceeded, logic in step 406 may flow back to step 402 where the environment continues to be sensed.

Sleep mode 200, 400, as discussed above in conjunction with FIGS. 2 and 4, may not necessarily constitute a complete shut down of the main processor 104. Accordingly sleep mode 200, 400 may be any sort of change in processor activity, interrupt activity, and so on that reduces power consumption. In particular, sleep mode may be a reduction in clock speed of the processor.

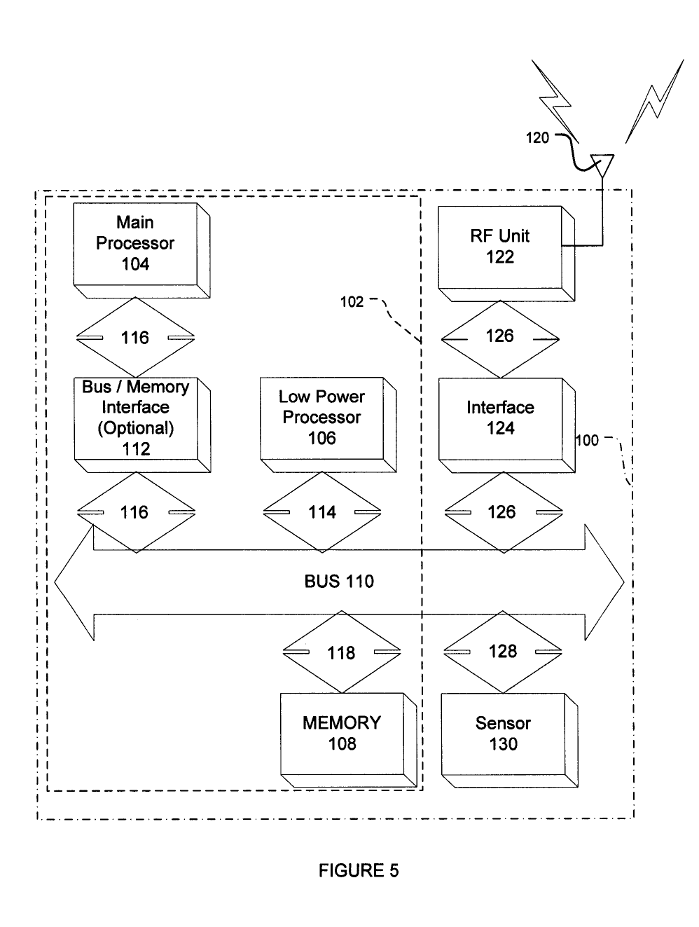

FIG. 5 is a schematic diagram showing another device in a mobile station. In particular, FIG. 5 shows a combination of the low power processor 106 used in conjunction with the sensor 130. In this aspect, the low power processor 106 may operate in conjunction with the method shown in FIG. 2 above, monitoring inputs and storing data. Similarly, sensor 130 may also operate to sense environmental changes as noted above in conjunction with the method of FIG. 4. However, FIG. 5 may use the combination of the sensor 130 to help the low power processor 106 make a determination as to whether or not the main processor 104 should be awakened and enter the normal operating mode. Accordingly, as shown in FIGS. 1, 3, and 5, the various aspects may be used either alone or in combination.

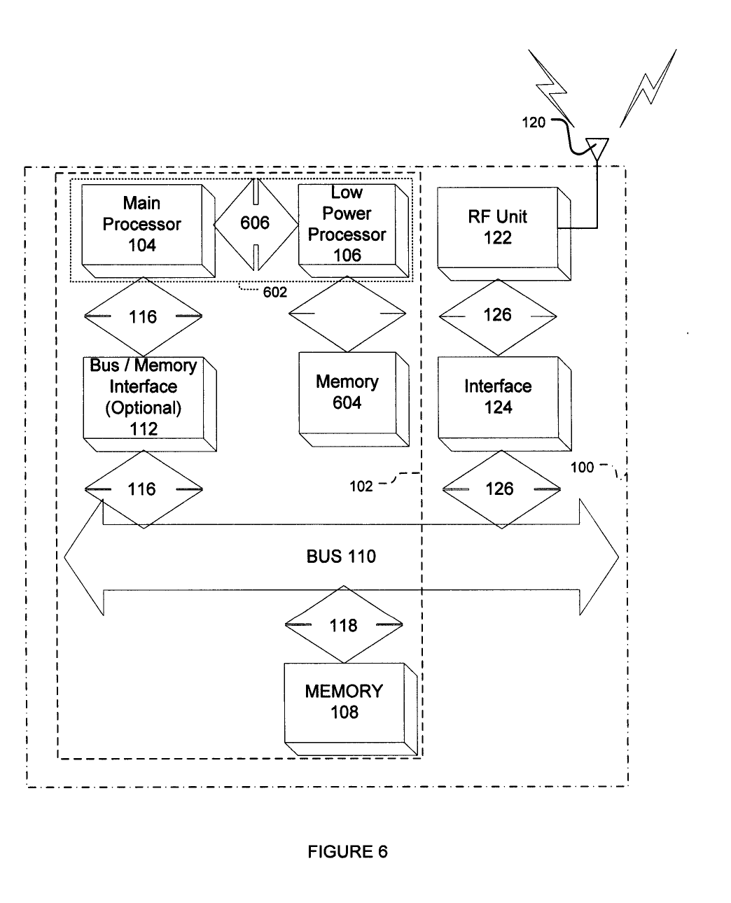

FIG. 6 is a schematic diagram showing another device that may be used in a mobile station. In particular, FIG. 6 is another arrangement of the circuit 102 that includes the low power processor 106 arranged for more direct (i.e., not through a bus) communication with the main processor 104 such as through a dedicated interface 606. Moreover, in order to reduce manufacturing costs and/or component size, the low power processor 106 may be integrated with and on the same chip 602 as the main processor 104. The low power processor 106 may further include a memory 604 that may or may not be dedicated for low power or sleep mode operations. The memory 604 may also be manufactured on the same chip 602 as noted above (not shown). In particular, the memory 604 may be constructed for low power operation. The method of operation of this aspect may be the method discussed above in conjunction with FIG. 2.

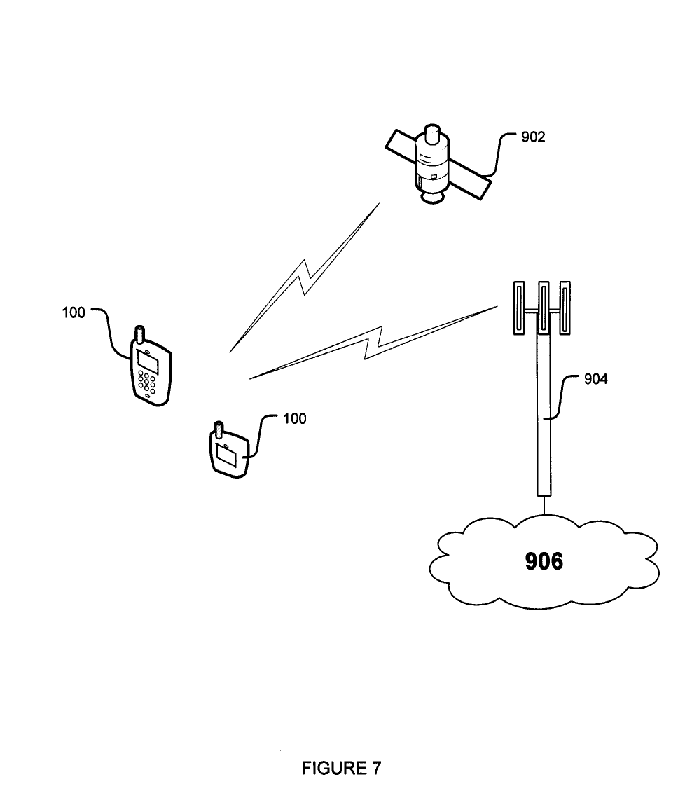

The mobile station 100 may include position determination techniques, including signal processing and acquisition, and may be used for various wireless communication networks 906 such as those associated with an antenna 904 shown in FIG. 7 for use with various mobile stations 100, such as a wireless wide area network (WWAN), a wireless local area network (WLAN), a wireless personal area network (WPAN), and so on. As used herein, mobile station (MS) refers to a device such as a cellular telephone, wireless communication device, user equipment, other personal communication system (PCS) device, or a position determination device employing position determination techniques or the like. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

As further shown in FIG. 7, a mobile station 100, 100 may receive signals from satellite(s) 902, which may be from a Global Positioning System (GPS), Galileo, GLONASS, NAVSTAR, GNSS, a system that uses satellites from a combination of these systems, or any SPS developed in the future, each referred to generally herein as a Satellite Positioning System (SPS). As used herein, an SPS will also be understood to include pseudolite systems.

The device and method described herein may be used with various satellite positioning systems (SPS), such as the United States Global Positioning System (GPS), the Russian Glonass system, the European Galileo system, any system that uses satellites from a combination of satellite systems, or any satellite system developed in the future. Furthermore, the disclosed methods and apparatuses may be used with positioning determination systems that utilize pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite” as used herein, is intended to include pseudolites, equivalents of pseudolites, and possibly others. The term “SPS signals” as used herein, is intended to include SPS-like signals from pseudolites or equivalents of pseudolites.

While the method and device described above are particularly advantageous for use in a mobile station receiving wireless signals from a SPS or wireless communication system, the method and device may be used in other digital signal processing environments outside of the SPS signal detection, signal acquisition and/or wireless communication environment. Moreover, the skilled artisan will appreciate that the various techniques above may be equally applicable to non-digital signal processing environments suffering from similar power constraints.

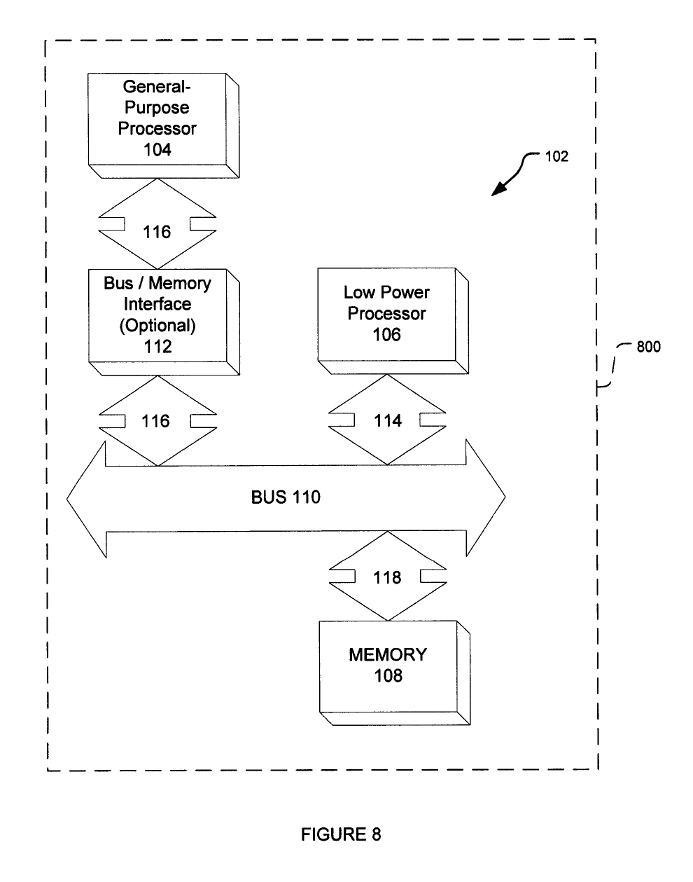

FIG. 8 shows a circuit implementation with components arranged and operated substantially similar to that of FIG. 1 outside the mobile station environment but which, prior to the device and method herein, also suffered from high power consumption during sleep mode. However, the device 800 has been modified to operate according to the principles of the device and method herein. Thus, the method described above may be implemented in non-digital signal processing application such as those shown in FIG. 8 in device 800.

The methodologies described herein may be implemented by various means depending upon the application. For example, these methodologies may be implemented in hardware, firmware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a memory, for example the memory 108 of mobile station 100, and executed by a processor, for example the main processor 104. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

While the device and methods have been described in terms of exemplary aspects, those skilled in the art will recognize that the device and methods can be practiced with modifications in the spirit and scope of the appended claims. These examples given above are merely illustrative and are not meant to be an exhaustive list of all possible designs, aspects, applications or modifications of the device and methods.

What is claimed:

1. A method of managing power in a mobile station comprising the steps of:
executing applications including signal processing applications;
entering a sleep mode in response to predetermined criteria;
monitoring at least one of signals, commands, inputs, and changes in environment when in the sleep mode; and
waking up responsive to said step of monitoring at least one of signals, commands, inputs, and changes in environment.

2. The method of managing power in a mobile station according to claim 1 wherein said step of monitoring comprises monitoring with a low power processor.

3. The method of managing power in a mobile station according to claim 2 further comprising the step of storing at least one of the inputs, signals, and commands in a memory for subsequent processing by a main processor.

4. The method of managing power in a mobile station according to claim 1 further comprising the step of waking up in response to said step of monitoring of at least one of the inputs, signals, and commands received in the mobile station exceeding a threshold.

5. The method of managing power in a mobile station according to claim 1 wherein said step of monitoring comprises sensing a change in the environment.

6. The method of managing power in a mobile station according to claim 5 wherein the change in environment comprises at least one of motion, temperature, direction, acceleration, magnetic field, and light.

7. The method of managing power in a mobile station according to claim 5 wherein said step of sensing initiates said step of waking up in response to a sensed change in environment that exceeds a predetermined threshold.

8. The method of managing power in a mobile station according to claim 1 wherein the predetermined criteria comprise at least one of a period of user inactivity, a reduced reception of wireless signals, no change in position, and no changes in the environment.

9. The method of managing power in a mobile station according to claim 1 further comprising the step of receiving wireless signals.

10. A power management circuit in a mobile station comprising:
a main processor configured to execute applications including signal processing applications and further configured to enter a sleep mode in response to predetermined criteria; and
a circuit configured to operate when said main processor is in the sleep mode comprising at least one of a low power processor and a sensor to monitor at least one of signals, commands, inputs, and changes in environment, said circuit waking up said main processor responsive to one of said low power processor and said sensor.

11. The power management circuit according to claim 10 wherein said circuit comprises said low power processor and wherein said low power processor is configured to monitor at least one of the inputs, signals, and commands in the mobile station.

12. The power management circuit according to claim 11 wherein said low power processor is configured to store at least one of the inputs, signals, and commands in a memory for subsequent processing by said main processor.

13. The power management circuit according to claim 10 wherein said low power processor is configured to wake up said main processor in response to the monitoring of at least one of the inputs, signals, and commands received in the mobile station exceeding a threshold.

14. The power management circuit according to claim 10 wherein said circuit comprises said sensor and said sensor is configured to sense a change in the environment.

15. The power management circuit according to claim 14 wherein the change in environment comprises at least one of motion, temperature, direction, acceleration, magnetic field, and light.

16. The power management circuit according to claim 14 wherein said sensor is configured to wake up said main processor in response to a sensed change in environment that exceeds a predetermined threshold.

17. The power management circuit according to claim 10 wherein the predetermined criteria comprise at least one of a period of user inactivity, a reduced reception of wireless signals, no change in position, and no changes in the environment.

18. The power management circuit according to claim 10 further comprising a radio frequency unit configured to receive wireless signals.

19. The power management circuit according to claim 18 wherein said low power processor is integrated into one of said main processor and said radio frequency unit.

20. A machine-readable medium comprising instructions, which, when executed by at least a main processor cause the main processor to manage power in a mobile station, the instructions comprising:
instructions to execute applications in a main processor including signal processing applications;
instructions to enter a sleep mode in response to predetermined criteria;
instructions to monitor at least one of signals, commands, inputs, and changes in environment when the main processor is in the sleep mode with at least one of a low power processor and a sensor; and
instructions to wake up the main processor responsive to one of the low power processor and the sensor.

21. The machine-readable medium according to claim 20 further comprising instructions to store at least one of the inputs, signals, and commands in a memory for subsequent processing by the main processor.

22. The machine-readable medium according to claim 20 further comprising instructions to wake up in response to the instructions to monitor at least one of the inputs, signals, and commands received in the mobile station exceeding a threshold.

23. The machine-readable medium according to claim 20 wherein the instructions to monitor comprises instructions to sense a change in the environment.

24. The machine-readable medium according to claim 23 wherein the change in environment comprises at least one of motion, temperature, direction, acceleration, magnetic field, and light.

25. The machine-readable medium according to claim 23 wherein the instructions to sense initiates the instructions to wake up in response to a sensed change in environment that exceeds a predetermined threshold.

26. The machine-readable medium according to claim 20 wherein the predetermined criteria comprise at least one of a period of user inactivity, a reduced reception of wireless signals, no change in position, and no changes in the environment.

27. The machine-readable medium according to claim 1 further comprising instructions to receive a wireless signals.

28. A power management circuit in a mobile station comprising:
means for executing applications including signal processing applications;
means for placing said executing means in a sleep mode in response to predetermined criteria;
means for monitoring at least one of signals, commands, inputs, and changes in environment when the executing means is in the sleep mode; and
means for waking up responsive to said monitoring means.

29. The power management circuit according to claim 28 wherein said monitoring means comprises means for low power processing and wherein said low power processing means is configured to monitor at least one of the inputs, signals, and commands in the mobile station.

30. The power management circuit according to claim 29 wherein said low power processing means is configured to store at least one of the inputs, signals, and commands in a memory for subsequent processing by said executing means.

31. The power management circuit according to claim 28 wherein said low power processing means is configured to wake up said executing means in response to the monitoring of at least one of the inputs, signals, and commands received in the mobile station exceeding a threshold.

32. The power management circuit according to claim 28 further comprising means for sensing a change in the environment.

33. The power management circuit according to claim 32 wherein the change in environment comprises at least one of motion, temperature, direction, acceleration, magnetic field, and light.

34. The power management circuit according to claim 32 wherein said sensing means is configured to wake up said executing means in response to a sensed change in environment that exceeds a predetermined threshold.

35. The power management circuit according to claim 28 wherein the predetermined criteria comprise at least one of a period of user inactivity, a reduced reception of wireless signals, no change in position, and no changes in the environment.

36. The power management circuit according to claim 29 further comprising a radio frequency receiving means for receiving wireless signals.

37. The power management circuit according to claim 36 wherein said low power processor is integrated into one of said executing means and said radio frequency receiving means.
